(19) United States
(12) Patent Application Publication
(10) Pub. No.: US 2026/0220383 A1
(43) Pub. Date: Jul. 30, 2026

(54) Intent-Conditioned Dual-Corpus Retrieval and Generation for Context-Aware Language Suggestions

(71) Applicant: Russell Todd Scheinberg, Portland, OR (US)

(72) Inventor: Russell Todd Scheinberg, Portland, OR (US)

(21) Appl. No.: 19/445,442

(22) Filed: Jan. 9, 2026

Related U.S. Application Data
(63) Continuation-in-part of application No. 19/336,460, filed on Sep. 22, 2025, now abandoned.
Application No. 19/336,460 is a continuation-in-part of application No. 19/075,764, filed on Mar. 10, 2025, now abandoned.
Application No. 19/075,764 is a continuation-in-part of application No. 18/898,570, filed on Sep. 26, 2024, now abandoned.
Application No. 18/898,570 is a continuation of application No. 18/634,527, filed on Apr. 12, 2024, now abandoned.
(60) Provisional application No. 63/495,755, filed on Apr. 12, 2023.

(51) Int. Cl. G06F 40/35; G06F 16/2457; G06F 16/248; G06F 40/166; G06F 40/242; G06F 40/253; G06F 40/289

(52) U.S. Cl. CPC G06F 40/35; G06F 16/24575; G06F 16/248; G06F 40/166; G06F 40/242; G06F 40/253; G06F 40/289

(57) ABSTRACT

A computer-implemented system generates context-appropriate language suggestions by coupling intent-conditioned dual-corpus retrieval with controlled generation. A controller derives a structured intent signature from dialogue context and intent parameters (e.g., communicative function, tone/stance, register, tense/aspect, domain). Using the same signature, the controller performs concurrent retrievals from a first corpus of reference exemplars and a second corpus of user-specific prior productions and/or target-style exemplars, and conditions a generator on the retrieved materials to produce candidate suggestions. Candidates are filtered by gating rules derived from the intent and policy parameters and then selected for presentation; in some embodiments the system prioritizes among compliant candidates. Accepted or edited outputs are written back to the second corpus to improve subsequent retrieval and conditioning. The approach applies to dialogue systems, writing assistants, email composition tools, and language-learning environments.

### TECHNICAL FIELD OF THE INVENTION

This disclosure relates to a system and method for intent-conditioned, dual-corpus retrieval for producing context-appropriate language suggestions

### BACKGROUND OF THE INVENTION

Parametric language models can produce fluent text, but on their own often yield suggestions that are off-intent (e.g., wrong communicative function), off-register (e.g., glib or over-formal), off-voice (e.g., stylistically foreign to the user), or insensitive to situational context. Various context-aware writing and messaging assistance systems address aspects of this problem. Large-scale assisted writing systems generate real-time, context-dependent continuations to reduce repetitive typing during email composition (see Chen et al., “Gmail Smart Compose: Real-Time Assisted Writing,” arXiv:1906.00080, 2019). Related approaches suggest completions or responses during interactive communications, including customer-service scenarios, where prior messages and other contextual information determine an appropriate completion (U.S. Pat. No. 9,807,037). Other systems leverage situational context (e.g., that a user is in a meeting) and assemble a context-specific corpus from sources associated with that situation to generate text suggestions (U.S. Pat. No. 12,299,390). While these systems can be effective, they do not employ a structured intent representation encoding communicative function, tone, register, and tense that serves as a shared retrieval key across heterogeneous corpora.

Retrieval-augmented generation (RAG) systems combine parametric language models with retrieval from an external corpus to ground or steer generation (see Lewis et al., “Retrieval-Augmented Generation for Knowledge-Intensive NLP Tasks,” arXiv:2005.11401, 2020). Some RAG approaches condition a language model on documents from a custom corpus or from multiple external sources, enabling tailored outputs without retraining (U.S. Pat. App. Pub. No. 2024/0362093). Research on intent-aware retrieval shows that retrieval can be conditioned on instructions or search intent (see Pan et al., “I3: Intent-Introspective Retrieval Conditioned on Instructions,” arXiv:2308.10025, 2023). However, these systems do not teach dual-corpus retrieval in which a first corpus supplies reference exemplars (providing native-like formulations) and a second corpus supplies user-specific prior productions or target-style exemplars (providing voice consistency), both queried using the same structured intent signature and jointly used to condition generation. A system that retrieves only from a reference corpus can produce correct, situationally appropriate output, but the result often sounds generic or foreign to the user—like a textbook template rather than something the user would naturally say.

Personalization based on user history is also known. Some systems learn a user embedding vector representing communication style (U.S. Pat. No. 11,425,064). Others build user-associated predictive dictionaries (U.S. Pat. No. 10,042,841) or generate personalized responses via user features in privacy-preserving configurations (U.S. Pat. App. Pub. No. 2024/0403564). These approaches personalize via user vectors or per-user models but do not combine intent-conditioned retrieval from a reference corpus with parallel intent-conditioned retrieval from a personalization corpus, followed by hard filtering of candidates against intent-derived constraints. Conversely, a system that retrieves only from user history can capture the user's voice but may surface fragmentary or incomplete formulations, and may perpetuate errors or lack appropriate structure for new communicative situations the user has not previously encountered.

More recent work addresses multi-source retrieval-augmented generation. UniMS-RAG (Wang et al., arXiv:2401.13256, 2024) unifies source selection, retrieval, and response generation using special tokens and refinement, but describes staged orchestration rather than concurrent retrieval under a single intent signature, and does not employ hard filtering rules derived from intent parameters. U.S. Pat. No. 12,373,506 describes a personalized RAG system that retrieves entity-associated content from a vector database, performs query augmentation including intent, supports multiple databases, and uses feedback to improve system components.

However, these systems do not disclose in combination: (i) a structured intent signature comprising communicative function, tone, register, tense, and domain fields that serves as a shared retrieval key across two corpora with distinct functional roles—a reference corpus providing native-like exemplars and a personalization corpus providing user voice and style evidence; (ii) hard filtering of candidate suggestions against intent- and policy-derived constraints (e.g., required slots, syntactic form, register) prior to presentation; and (iii) write-back of accepted or edited outputs to the personalization corpus, indexed by the intent signature and retrieval identifiers, to expand coverage for future retrieval—as distinct from feedback that tunes model parameters.

To fill this gap, the present system (i) forms a structured intent representation of the current turn, (ii) performs concurrent, intent-conditioned retrievals over heterogeneous corpora—such as a reference corpus (first corpus) and a personalization corpus comprising the user's prior productions and/or target-style exemplars (second corpus)—and (iii) computes divergences relative to the intent signature to identify mismatches (e.g., tense, register, or communicative function) that matter for the turn. By conditioning LLM generation on the retrieved materials and using the divergence signals to guide selection, the present system can deliver candidate utterances that are both authentic (grounded in a native corpus) and personalized (consistent with the user's historical voice or chosen style).

The invention rests on the following insight: effective language use depends not only on grammar and vocabulary, but also on the ability to operate across styles: colloquial vs. formal, business vs. storytelling, impersonating professional roles, adopting dialects, or shifting stance (conciliatory vs. aggressive). Developing this flexibility is part of improving first-language competence and acquiring a second language: native speakers and learners both must learn how to perform in new registers and cultural settings. Whether acquiring a second language or adapting to a new professional domain, users face the same core challenge: learning to operate fluently in unfamiliar registers while sounding like themselves. A system that can suggest intent-conditioned utterances across different styles therefore benefits both L2 learners and native speakers who wish to adapt to new domains or voices. Over repeated practice, accepted suggestions and user edits are logged and written back to the personalization/style corpus, so that coverage improves and selection increasingly reflects the user's voice; early sessions therefore rely more on the reference corpus, while later sessions increasingly surface user-consistent phrasing.

### SUMMARY OF THE INVENTION

An object of the invention is to generate language suggestions that are simultaneously native-like (correct, situationally appropriate, well-formed) and self-like (consistent with the user's voice and phrasing patterns).

A structured representation of communicative intent guides concurrent searches over heterogeneous corpora, including a reference/exemplar corpus and a personalization corpus comprising past user utterances and/or target-style exemplars—and generation is conditioned on the retrieved materials. The approach may be applied in text-generation applications including dialogue systems, writing assistants, email composition tools, and language-learning environments.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more thorough understanding of the present invention, and advantages thereof, reference is now made to the following descriptions taken in conjunction with the accompanying drawings, in which:

FIG. 1 is an overview of a system in accordance with an embodiment of the invention;

FIG. 2 illustrates the structure of an intent signature of the system of FIG. 1;

FIG. 3 is a functional diagram of the controller of the system of FIG. 1;

FIG. 4 illustrates corpus specific retrieval scoring of the system of FIG. 1;

FIG. 5 is a flowchart showing steps of the system of FIG. 1;

FIG. 6 shows an exemplary presentation interface for a single-terminal embodiment; and

FIG. 7 illustrates dual-corpus retrieval and conditioning for an exemplary rescheduling turn.

### DETAILED DESCRIPTION

In one aspect, the present system forms a structured intent signature from current dialogue context and intent parameters (e.g., communicative function, register, tone/stance, tense/aspect, domain), performs concurrent retrievals conditioned on the same intent signature from a first corpus of reference exemplars and a second corpus of user-specific history and/or target-style exemplars, computes divergences relative to the intent signature between the retrieval sets, and conditions a generator on the retrieved materials to produce candidate language suggestions. Candidates are filtered by gating rules derived from the intent and policy parameters and are optionally ranked and then selected for presentation to a user for use.

In some embodiments, the policy parameters may be provided or influenced by other modules or systems, such as a teacher, planning, or configuration module. These modules may draw on curriculum, analytics, or user goals to define vocabulary, syntax, or stylistic scaffolding that affect how candidates are filtered, refined, or presented. In other embodiments, generated suggestions may be presented directly to the user or routed through another interface for review or curation, depending on the application.

As used herein:
a. Communicative intent denotes the task/context for a turn (e.g., communicative function, tone/stance, register, tense/aspect, domain) and is encoded in Intent parameters.
b. Intent signature denotes a structured representation derived from dialogue context and intent parameters and used to condition retrieval over the first and second corpora.
c. Policy parameters denote session or planning preferences (e.g., difficulty, emphasis, vocabulary/syntax scaffolding) that influence gating and presentation but do not alter the retrieval key.

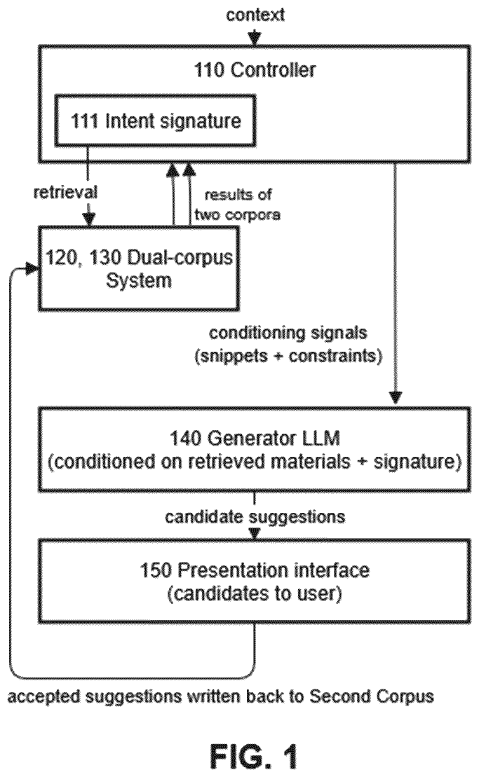

System Overview (see FIG. 1). A preferred system comprises:
(i) a first corpus (reference/exemplar corpus) storing authentic exemplars indexed by embeddings and optional linguistic metadata;
(ii) a second corpus (personalization/style corpus) storing user-specific prior productions and/or target-style exemplars, indexed by embeddings and optional metadata;
(iii) a Controller that constructs the intent signature, performs concurrent retrievals from the first and second corpora conditioned on that signature, computes intent-relative divergences between the result sets, derives gating rules from the intent and policy parameters, conditions a generator on the retrieved materials to draft candidate suggestions, and filters and (optionally) ranks the candidates before selection; and
(iv) an interface that presents selected candidates to the user directly for editing or use.

The subsystem is application-agnostic. It can be used in dialogue systems, writing assistants, email composition tools, and language-learning environments. In some embodiments, external modules (e.g., a teacher or planning component) provide policy parameters such as required vocabulary, syntactic constructions, or stylistic scaffolding that influence gating or an optional second refinement stage. In other embodiments, suggestions may be presented directly to the user or routed through another interface.

The present disclosure describes systems and methods for producing context-appropriate language suggestions by means of intent conditioned retrieval from two heterogeneous corpora. In one embodiment, a system includes a first corpus that stores reference exemplars, a second corpus that stores user specific productions and/or target style exemplars, and a controller configured to derive an intent signature for each turn and to coordinate retrieval, generation, and selection of candidate suggestions.

For each turn in a dialogue or text-generation session, the controller derives a structured intent signature from the current context and one or more intent parameters. The intent parameters may include, without limitation, communicative function, tone or stance, register, tense or aspect, domain, locale, and required information slots. The intent signature may comprise discrete fields and one or more vector encodings, and serves as a shared key for retrieving materials from both the first and second corpora.

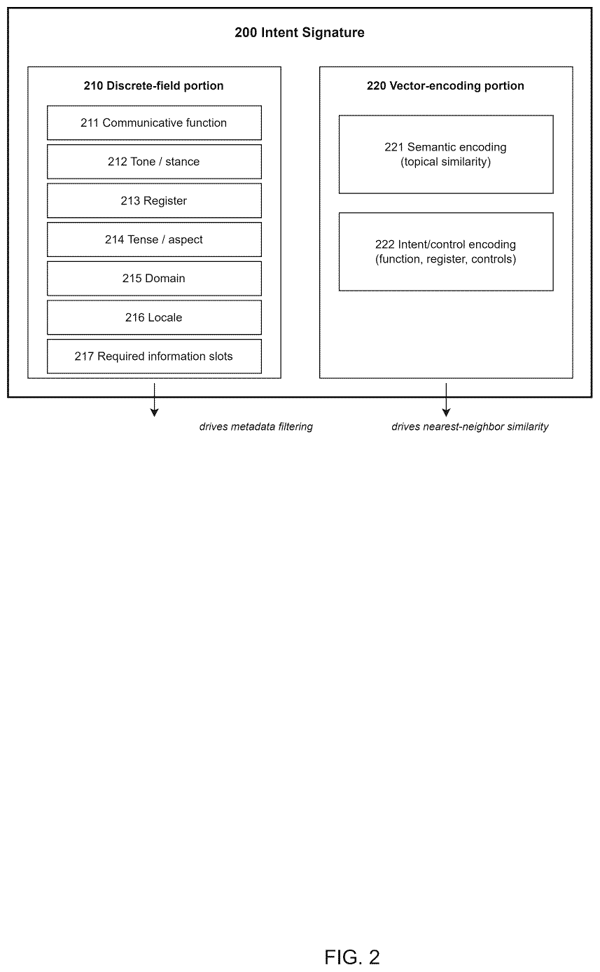

Intent signature representation (see FIG. 2). In some embodiments, the intent signature (200) includes a discrete-field portion (210) comprising at least a communicative function field (211) and one or more additional fields selected from tone or stance (212), register (213), tense or aspect (214), domain (215), locale (216), and required information slots (217), and further includes a vector-encoding portion (220) derived from the dialogue context. The vector-encoding portion (220) may include a semantic encoding (221) used for topical similarity and an intent/control encoding (222) that captures function, register, and related controls. The signature (200) serves as a shared key for concurrent retrievals from both the first corpus (120) and the second corpus (130).

The discrete fields (210) and vector encodings (220) may be used in combination during retrieval, conditioning, and selection. In some embodiments, discrete fields (210) drive metadata-based filtering to exclude items that cannot satisfy hard constraints, while vector encodings (220) drive similarity-based ranking among items that pass the filter. In other embodiments, both portions may contribute to scoring, or one portion may serve as the primary retrieval key while the other informs re-ranking, gating, or generator conditioning. Regardless of the specific implementation, both portions of the intent signature (200) are used to query both the first corpus (120) and the second corpus (130); the same signature thus serves as a unified retrieval key across heterogeneous corpora, ensuring that retrieved materials from both sources are aligned to the same communicative goal.

This architecture enables the system to surface suggestions that are simultaneously native-like (grounded in authentic usage from the first corpus (120)) and self-like (consistent with the user's own voice and preferred phraseology as captured in the second corpus (130)). The discrete fields (210) ensure communicative appropriateness by constraining retrieval to items that match the target function, register, and domain. The vector encodings (220) enable finer stylistic alignment by ranking items according to phraseological similarity. For language learners, the result is output that models correct, situationally appropriate formulations while remaining authentic to the learner's emerging voice rather than imposing a generic or foreign-sounding style.

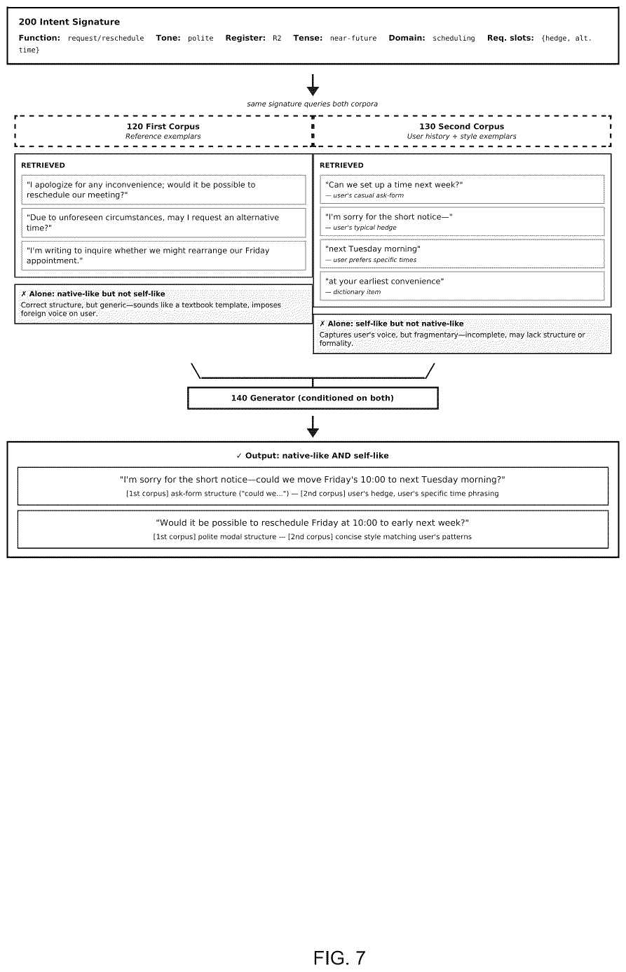

FIG. 7 illustrates this principle for an exemplary rescheduling scenario: retrieved items from the first corpus (120) alone provide correct structure but sound generic, while retrieved items from the second corpus (130) alone capture the user's voice but are fragmentary; conditioning on both yields output that combines native-like structure with the user's characteristic phrasing.

The first corpus (reference/exemplar corpus) contains native-like or otherwise approved exemplars, indexed by embeddings and optionally by linguistic metadata such as function, register, tense/aspect, domain, and locale. The second corpus (personalization/style corpus) contains user-specific resources and/or target-style exemplars, including prior productions (e.g., transcripts of interactive sessions or user-authored documents) and style targets selected by the user. Items in the second corpus may be indexed by embeddings and metadata, including timestamp, provenance identifier, domain label, locale, and style label.

Conditioned on the same intent signature, the controller performs concurrent retrievals from the first and second corpora. In one implementation, approximate nearest-neighbor search over one or more embeddings is combined with metadata filtering derived from the intent parameters to obtain intent-aligned subsets from each corpus. The system may deduplicate near-duplicate results and limit the number of retrieved items per corpus to meet latency objectives. In some embodiments, the controller issues multiple queries over subsets of the discrete fields and unions the results to increase recall when strict conjunctive filtering would yield sparse results; the vector encodings then rank the aggregated candidates by overall similarity to the intent signature.

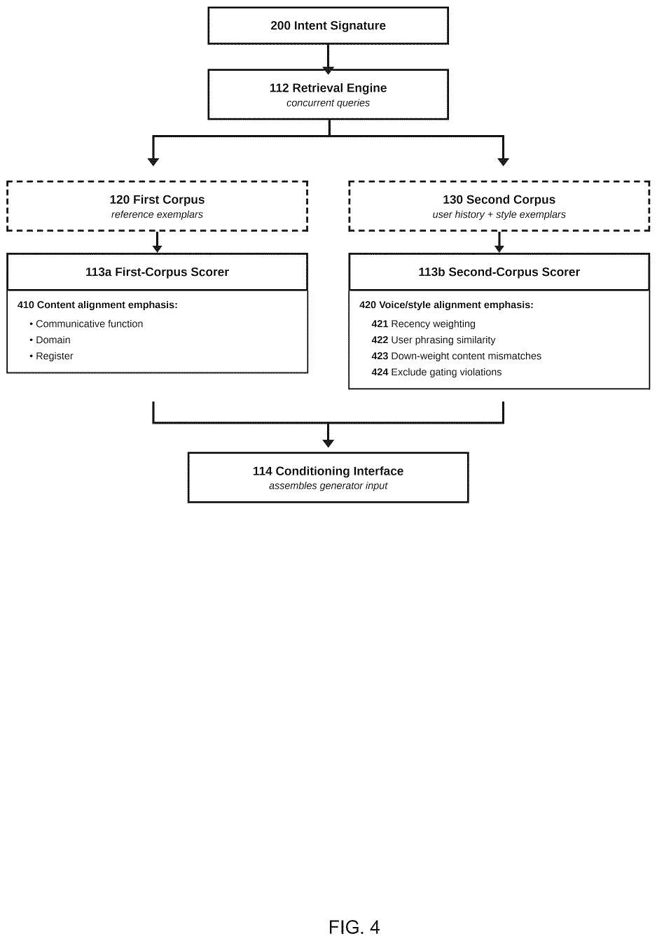

Corpus-specific retrieval scoring (see FIG. 4). Retrieval is intent conditioned for both corpora but uses corpus-appropriate emphasis. The retrieval engine (112) issues concurrent queries to the first corpus (120) and the second corpus (130) using the same intent signature (200). For the first corpus (120), a first-corpus scorer (113a) emphasizes content alignment (410) to the intent signature, including alignment to communicative function, domain, and register. For the second corpus (130), a second-corpus scorer (113b) emphasizes voice and style alignment (420), including tone or stance and register, as well as recency (421) and similarity to the user's prior phrasing patterns (422), while downweighting items with hard content mismatches (423) and excluding items that violate gating constraints (424). Scored results from both scorers are passed to the conditioning interface (114) for assembly into generator input. Thus, second-corpus items contribute style and voice evidence even when they do not encode the entire intent.

The controller may compare retrieved materials to the intent signature to compute one or more divergence measures that quantify mismatches along linguistic dimensions such as register, tense/aspect, hedging, syntactic form, domain lexicon, and brevity. These measures can be computed per retrieval set and/or per candidate (after generation) and can be used to inform selection policies. Divergence computation is not required in every embodiment.

The controller derives gating rules from the intent signature and applicable policy parameters. Gating rules constitute hard constraints enforced prior to presentation and may include, by way of example, requiring a question or ask-form, enforcing inclusion of required information slots, enforcing locale-specific formatting, requiring or preferring vocabulary drawn from a user dictionary, suppressing disallowed categories of language, and enforcing style-safety thresholds (e.g., similarity limits to avoid near-verbatim reproduction of style exemplars).

The controller then conditions a generator on the retrieved materials and the intent signature to produce one or more candidate suggestions. The generator may be a language model configured to accept retrieved snippets or features as context. Conditioning may include providing exemplar passages, structured constraints, control tokens, or other signals sufficient to guide candidate generation without requiring verbatim copying.

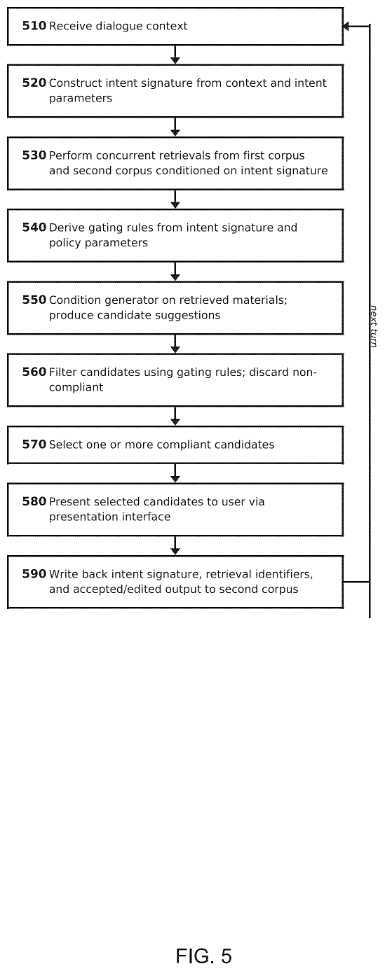

Generated candidates are filtered using the gating rules. Candidates that fail any required constraint are discarded. In some embodiments, remaining candidates are prioritized (e.g., using divergence measures, policy weights, or voice/style similarity to the user's benign patterns), although prioritization or ranking is not required in all implementations. The controller selects one or more candidates for presentation. The write-back records the intent signature, identifiers of retrieved items used during conditioning, and the accepted or edited output, which is persisted in the second corpus (see FIG. 5).

Method overview (see FIG. 5). The controller performs the following steps for each turn. At step (510), the controller receives dialogue context. At step (520), the controller constructs an intent signature (200) from the dialogue context and intent parameters. At step (530), the controller performs concurrent retrievals conditioned on the intent signature from the first corpus (120) and the second corpus (130) to obtain respective sets of retrieved materials. At step (540), the controller derives gating rules from the intent signature and applicable policy parameters. At step (550), the controller conditions a generator (140) on the retrieved materials and the intent signature to produce candidate language suggestions. At step (560), the controller filters candidates using the gating rules, discarding non-compliant candidates. At step (570), the controller selects one or more compliant candidates for presentation. At step (580), selected candidates are presented to a user via a presentation interface (150). At step (590), the controller writes back the intent signature, identifiers of retrieved items used during conditioning, and the accepted or edited output to the second corpus (130). The method may then return to step (510) for a subsequent turn.

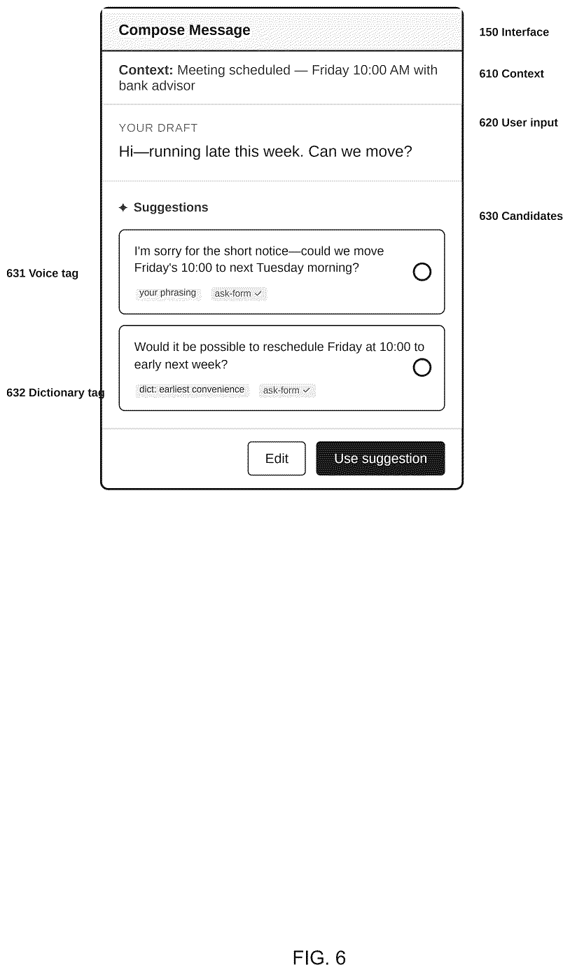

One or more selected suggestions are presented for user consumption (see FIG. 6). In some embodiments, suggestions are displayed directly to the user for acceptance, editing, or use, along with optional indicators such as voice alignment tags (631) showing correspondence to the user's prior phrasing patterns or dictionary tags (632) showing inclusion of items from the user's vocabulary list. In other embodiments, suggestions are routed through another interface for review or curation prior to presentation. Interaction artifacts, including the intent signature, identifiers of the retrieved items, candidate sets and selection outcomes, and any user edits, may be written back to update the second corpus and improve subsequent retrieval and conditioning.

When the second corpus is below a coverage threshold, the system may construct a style profile from user-provided samples or explicit parameters (including tone or stance) and treat the profile as seed entries of the second corpus for retrieval and conditioning. In other scenarios where the first corpus alone suffices to meet application requirements, the controller may proceed with retrieval from the first corpus while retaining the same conditioning and gating pipeline. These fallback modes do not limit the dual-corpus embodiments described above.

Slot filling. Exemplar retrievals may contain representative placeholders (e.g., “early next week”). After generation and gating, a slot-filling step may bind placeholders to concrete values inferred from context or obtained via minimal user input (e.g., replacing “early next week” with “Tuesday 2:00 PM”), without altering the core pipeline.

The system may optionally perform a post-generation lexical injection step. Given a lexical specification (for example, a list of one or more words or collocations derived from policy parameters, a teacher plan, or user selection), the controller rewrites one or more compliant candidates to include at least one specified item while preserving the intent signature constraints and all gating rules. Rewriting may use constrained decoding or minimal-edit optimization (e.g., selecting the rewrite with the lowest edit distance to the original that satisfies the lexical specification and all gates). If no compliant rewrite exists, the original compliant candidate is retained.

Repeated practice with similar scenarios grows the second corpus with relevant, context-labeled examples. During an initial cold-start period, retrieval may rely primarily on the first corpus; as the second corpus accumulates accepted outputs and edits, relative reliance on the second corpus during conditioning and selection increases, enabling the system to suggest phrasing that increasingly reflects the user's voice and preferred phraseology, and to align with a personal or target-style profile.

Technical effects. The disclosed pipeline yields at least the following technical effects: (i) increased compliance with required information slots and intent constraints relative to generator-only systems; (ii) improved adherence to target register, tense/aspect, and tone/stance; (iii) reduced edit distance between generated candidates and accepted user outputs due to conditioning on user-specific materials; and (iv) bounded latency via pre-indexed nearest-neighbor retrieval and controlled candidate counts per corpus.

The described pipeline is application-agnostic and may be used in dialogue systems, writing assistants, email composition, and language-learning environments. External modules, such as a teacher or planning component, may provide policy parameters (e.g., vocabulary or syntactic scaffolding, style preferences) that influence gating or a second refinement stage applied to one or more selected candidates; such modules are not required by the core system.

### Preferred Embodiments

In one embodiment, the system is deployed as a language-learning assistant in which suggestions are presented to the learner within a single application interface. The system includes a first corpus of reference exemplars and a second corpus of personalized materials, and a controller configured as described above to derive an intent signature, perform concurrent retrievals, condition a generator, apply gating rules, and select candidates for presentation.

The first corpus stores reference or exemplar utterances drawn from native-like usage and/or approved teaching materials. Items are indexed by one or more vector embeddings (e.g., 512-1536 dimensions) and optional linguistic metadata such as communicative function, register, tense/aspect, domain, and locale. The second corpus stores personalized resources, including transcripts of the learner's prior utterances produced within the framework of the present invention or imported from another source. Items are likewise indexed by embeddings and optional metadata (e.g., timestamp, provenance identifier, domain label, locale, style label). The system may maintain approximate nearest-neighbor indices (e.g., HNSW) per corpus to bound retrieval latency (for example, ≤250 ms per corpus for top-k retrieval, where k is in the range 3-10).

During operation, for each learner turn the controller encodes an intent signature from context and intent parameters (for example, function=request, tone=neutral-polite, register=R2, tense=near-future, domain=banking, required slots={ask-form, proposed time}). Using the same signature, the controller performs concurrent retrievals from the first and second corpora by combining embedding similarity (e.g., cosine) with metadata constraints derived from the signature. The system may cap the number of retrieved items per corpus (e.g., k1=k2=5) and remove near duplicates (e.g., similarity ≥0.98) to meet a target end-to-end latency (for example, ≤900 ms median).

The controller derives gating rules from the intent and any active policy parameters. Examples include: require an ask-form; require presence of one or more required slots; enforce locale formatting (e.g., date and currency conventions); require or prefer inclusion of vocabulary from the learner's dictionary; suppress disallowed patterns; and enforce style-safety thresholds, such as limiting per-candidate token-level similarity to any single reference item below a threshold τ (for example, τ∈[0.85,0.95]) and/or limiting n-gram overlap to a maximum proportion (for example, ≤0.5 for 4-grams). These constraints are applied as hard gates prior to presentation.

The generator is conditioned on the retrieved materials and the intent signature and produces a small set of candidate suggestions (for example, N=2-4). Conditioning may include providing exemplar snippets, structured slot requirements, control tokens, and a vocabulary preference list derived from the dictionary. Generated candidates are filtered by the gating rules. In some implementations, the controller may prioritize among compliant candidates using divergence-reduction signals, policy weights, or similarity to benign aspects of the learner's prior phrasing; prioritization is not required in every embodiment. One or more candidates are then selected and presented to the learner for use or editing (see FIG. 6). Interaction artifacts (intent signature, identifiers of retrieved items, selected output, and any edits) are written back to the second corpus to improve subsequent retrieval and conditioning.

By way of illustration in the single-terminal embodiment (see also FIG. 7), consider the learner context “I need to schedule a meeting with the bank.” The controller encodes an intent signature with, for example: communicative function=request/schedule; tone=polite; register=R2; tense/aspect=near-future; domain=banking; locale=US; required information slots={ask-form, appointment noun, time window}. Using the same signature, the controller retrieves k1=3 items from the first corpus (for example, “Would it be possible to schedule an appointment at the downtown branch?”, “May I set up a meeting with a banker next week?”, “Could we arrange a time to discuss my account?”) and k2=3 items from the second corpus (for example, prior learner productions such as “I want to meet bank” and “Can we set up a time?”, along with dictionary entries including “set up an appointment” and “at your earliest convenience”). Gating rules require the ask-form, the “appointment/meeting” noun, and a time window; they prefer inclusion of one dictionary item; they enforce style-safety by capping token-level similarity to any single reference item at τ=0.90 and 4-gram overlap ≤0.50. The generator is conditioned on the retrieved materials and produces N=3 candidates, such as: C1 “Would it be possible to set up an appointment next Tuesday morning?”, C2 “Could we arrange a meeting at your earliest convenience next week?”, and C3 “Change meeting please.” The gating filter discards C3 (no ask-form; missing required slots). The controller selects C1 (includes a dictionary collocation and a specific time window) and presents it to the learner. The system writes back the intent signature, identifiers of the retrieved items, and the accepted surface form to the second corpus.

The foregoing embodiment supports both micro-scaffolding and macro-scaffolding without altering the core pipeline. In micro-scaffolding, policy parameters may require or prefer specific grammatical or lexical targets, and the controller enforces them via gating and conditioning. Examples include: (i) subjunctive mood in request formulations (e.g., require patterns such as “It is important that I be...”, with gating rejecting indicative realizations for that slot); (ii) phrasal verbs for everyday actions (e.g., prefer “set up,” “follow up,” “look into,” “reach out,” with a requirement that at least one item from a specified list L appear in the candidate); and (iii) domain collocations (e.g., “schedule an appointment,” “file a claim,” “make a payment,” “reach a decision”), enforced as required slots or soft preferences with minimum presence counts (for example, ≥1 collocation from a banking list per candidate). In macro-scaffolding, scene-level policy can adjust formality across multiple turns; for instance, in a three-turn practice scenario, T1 may allow informal exploration (R1 tolerated), T2 may require neutral-polite (R2) with a hedge and ask-form, and T3 may enforce formal (R3) style for a written follow-up (e.g., require openings such as “Dear . . . ,” modal verbs “would/shall,” and forbid colloquialisms such as “hey,” “gonna”). The controller applies these session policies by deriving gating rules (must/forbid/required slots) from the active intent signature plus the macro policy for the current turn index, while conditioning the generator with a vocabulary preference list drawn from the user's dictionary; candidates that fail required targets are filtered prior to presentation.

### Four-Terminal Dialogue Practice Embodiment

In another embodiment, the system comprises four terminals: a learner terminal operated by the user; a teacher terminal; an interlocutor terminal; and a dialogue expert terminal. The learner terminal provides the user interface through which the learner views and selects suggestions. The teacher terminal or module supplies policy parameters that influence gating and, in some embodiments, a second refinement pass; such parameters may include a vocabulary list, a set of target constructions, and scene-level goals. The teacher terminal may be a computer-based system or a human teacher. The interlocutor terminal represents a conversation partner and remains independent from the suggestion generator during live dialogue. The interlocutor terminal may be a language model or a speaker of the target language with or without special training who interacts naturally with the user of the learner terminal. The expert terminal presents selected candidates for review and allows accept, edit, or withhold actions prior to delivery to the learner. The expert terminal can be operated by a computer system, or a human dialogue expert who receives suggestions from the dual-corpus system, curates, annotates and selectively passes on potential utterances to the user; alternatively, in lieu of a human dialogue expert, the expert terminal may be operated by a co-learner or buddy of the user: despite not being an expert, the dual-corpus system allows the non-expert to offer useful and targeted suggestions to the user, and the non-expert also has the opportunity to learn concomitantly.

In use, the controller derives an intent signature from ongoing dialogue context and scene metadata and performs concurrent retrievals from the first and second corpora as described above. The teacher module can provide or adjust policy parameters on a per-session or per-scene basis (for example, require inclusion of at least one item from a prescribed vocabulary list; encourage simple present over present progressive; require a hedge token for requests). The controller applies gating rules derived from the intent and policy parameters and conditions the generator on the retrieved materials to produce candidate suggestions. Candidates that violate gating are discarded. Compliant candidates are provided to the expert terminal for curation, selection and/or editing, and are then delivered to the learner terminal. The interlocutor exchanges messages only with the learner; the suggestion generator does not directly alter interlocutor behavior.

The following illustrates a single turn in the four-terminal embodiment. Context indicates a scheduled appointment on Friday at 10:00; the learner intends to reschedule. The intent parameters include function=request/reschedule, tone=neutral-polite, register=R2, tense=near-future, domain=business scheduling, and required slots={apology/hedge, proposed alternative}. The controller encodes the intent signature and retrieves k1=5 items from the first corpus (e.g., native-like rescheduling requests) and k2=5 items from the second corpus (e.g., the learner's prior polite requests and dictionary entries). Gating rules require ask-form and the required slots, enforce locale date format, and prefer inclusion of one item from the dictionary. The generator produces three candidates conditioned on the retrieved materials, for example: “I'm sorry for the short notice—could we move Friday's 10:00 to next Tuesday morning?”; “Would it be possible to reschedule Friday at 10:00 to early next week?”; “Please change the meeting.” The third candidate is discarded by the gating filter for failing the ask-form requirement and missing required slots. The expert terminal selects the first candidate and optionally edits it to match house style. The accepted suggestion is presented to the learner terminal and logged; identifiers of the retrieved items and the accepted surface form are written back to the second corpus.

The four-terminal embodiment may additionally log curation outcomes, including edit distance from the generated candidate to the accepted output, for use in subsequent refinement of retrieval parameters or optional prioritization. These logs and any transcripts form part of the second corpus and may be used to expand coverage in subsequent sessions.

The embodiments described above are exemplary and non-limiting. Variations include different index types for retrieval, different forms of the intent signature (including one or more vector encodings and discrete fields), different gating rule sets, and different presentation interfaces. The core pipeline—deriving an intent signature, performing concurrent retrievals from a first and a second corpus conditioned on the same signature, conditioning a generator on the retrieved materials, applying gating rules, and selecting candidates for presentation—remains as described.

The dual-corpus system is modality-agnostic: in all modes the pipeline is unchanged—derive an intent signature from context, perform concurrent retrieval from a first (reference/exemplar) corpus and a second (personalization/style) corpus conditioned on the same signature, condition a generator on the retrieved materials, apply gating rules, and select candidates for presentation.
Text. Typed turn-taking; low latency; candidates presented for accept/edit/use; accepted outputs write back to the second corpus.
Speech. Spoken input with automatic transcription; the second corpus updates with transcripts; presentation may be text, TTS, or both.
Multimodal. Audio/video or AR/VR adds scene cues without altering the pipeline.
In-situ mobile/wearable. Minimal-distraction prompts in live contexts; suggestions and outcomes are logged for later review.
   These modalities illustrate I/O options and do not limit the invention; equivalent interfaces or transports may be used.

### Example —Single-Terminal Learning Assistant (illustrative; see FIG. 7).

Context. Prior context (e.g., a thread title or calendar data from a host app) indicates a meeting proposed for Friday 10:00. The user types: “Hi—running late this week. Can we move?”

Intent signature. The controller encodes: function =request/reschedule; tone/stance=neutral-polite; register=R2; tense/aspect=near-future; domain=business scheduling; locale=US; required slots={apology/hedge, proposed alternative time window}. The signature includes discrete fields plus vector encodings and is used as a shared key for both retrievals. Retrieval uses a shared intent key but corpus-specific scoring (content emphasis for the first corpus; voice/recency emphasis for the second corpus).

Dual retrieval. Using the same signature, the controller retrieves k1=3 reference exemplars from the first corpus (ANN over embeddings+metadata filters), e.g., “Would it be possible to reschedule our meeting to Tuesday afternoon?”, “May we move the meeting to early next week?”, “Could we arrange another time to discuss my account?” It also retrieves k2=3 user-specific items from the second corpus: a concise opener the user often uses (“Thanks for the note— . . . ”), a prior polite scheduling attempt (“Could we set up a time next week?”), and another brief request with the user's typical hedge. (Reference exemplars provide content patterns; personal items provide voice/style—neither is expected to encode the entire intent alone.)

Gating. Derived from the signature and policy: require ask-form; require {hedge, proposed alternative}; enforce locale-specific date/time; style-safety limits (e.g., token-level similarity <0.90 to any single reference and ≤0.50 4-gram overlap); and prefer at least one item from the user's vocabulary list when available.

Conditioned generation. The generator receives the retrieved snippets+explicit constraints. It produces three candidates:
C1 “I'm sorry for the short notice—could we move Friday's time to next Tuesday morning?”
C2 “Would it be possible to reschedule Friday at 10:00 to early next week?”
C3 “Change the meeting please.”

Filtering and selection. C3 fails gates (no ask-form; missing required slots) and is discarded. The controller selects two compliant alternatives (C1 and C2) for presentation so the learner can compare.

Slot filling. If a candidate carries a generic alternative (“early next week”), a slot-filling step binds it to a concrete value (e.g., Tuesday 2:00 PM) inferred from context or a quick user prompt.

(Optional) post-generation lexical injection. If the teacher or user specifies a collocation (e.g., “set up an appointment”), the controller rewrites a compliant candidate to include it while preserving all gates; if no compliant rewrite exists, the original stands.

Presentation and Write-back. The system presents the suggestions to the user, who can opt to utilize one of the suggestions verbatim, edit the suggestion, for example, integrating phrases from different suggestions, or ignore the suggestions and create their own response (see FIG. 6). The system logs the intent signature, retrieval IDs, and the accepted surface form (or edited version) to the second corpus to improve future retrieval and conditioning.

FIG. 1 is a system overview. A controller (110) derives an intent signature (111) from context and uses it to query a first corpus (120) of reference exemplars and a second corpus (130) of personalization/style materials. Results from both corpora are returned to the controller, which conditions a generator (140) on the retrieved materials and the intent signature to produce candidate suggestions for a presentation interface (150). Accepted or edited outputs are written back to the second corpus (130) for use in subsequent turns.

FIG. 2 illustrates the structure of an intent signature (200), comprising a discrete-field portion (210) with fields for communicative function (211), tone or stance (212), register (213), tense or aspect (214), domain (215), locale (216), and required information slots (217), and a vector-encoding portion (220) with a semantic encoding (221) and an intent/control encoding (222).

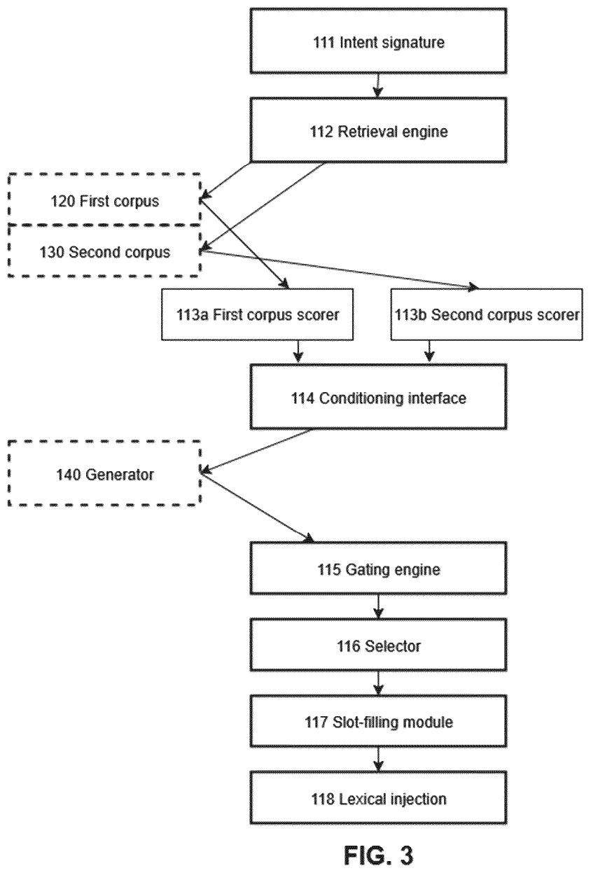

FIG. 3 is a functional diagram of the controller (110). The controller includes an intent signature module (111) that encodes dialogue context and intent parameters. A retrieval engine (112) issues concurrent queries to the first corpus (120) and the second corpus (130). Returned results are scored by a first-corpus scorer (113a) emphasizing content alignment and a second-corpus scorer (113b) emphasizing voice and recency. A conditioning interface (114) passes selected materials and constraints to the generator (140). A gating engine (115) enforces hard constraints, and a selector (116) chooses compliant candidates, optionally with prioritization. Additional modules include a slot-filling component (117) to bind placeholders to concrete values and a post-generation lexical injection module (118) to insert specified collocations while preserving gating constraints.

FIG. 4 illustrates corpus specific retrieval scoring. A retrieval engine (112) queries both corpora using the same intent signature. A first-corpus scorer (113a) emphasizes content alignment (410). A second-corpus scorer (113b) emphasizes voice/style alignment (420), recency (421), user phrasing similarity (422), downweighting of content mismatches (423), and exclusion of gating violations (424). Results pass to a conditioning interface (114).

FIG. 5 is a method flowchart showing steps for receiving context (510), constructing an intent signature (520), performing concurrent retrieval (530), deriving gating rules (540), conditioning a generator (550), filtering candidates (560), selecting candidates (570), presenting to user (580), and writing back to the second corpus (590).

FIG. 6 illustrates an exemplary presentation interface (150) for a single-terminal embodiment. The interface displays context information (610) derived from a host application, a user input area (620), and a candidate suggestions area (630) presenting filtered candidates for user selection. Each candidate may include a voice tag (631) showing correspondence to the user's prior phrasing patterns and a dictionary tag (632) showing inclusion of items from the user's vocabulary list.

FIG. 7 illustrates dual-corpus retrieval and conditioning for an exemplary rescheduling turn. An intent signature (200) serves as a shared key for concurrent queries to the first corpus (120) and the second corpus (130). Retrieved items from the first corpus provide native-like structural patterns; retrieved items from the second corpus capture the user's voice and phrasing patterns. The generator (140), conditioned on materials from both corpora, produces output candidates that are simultaneously native-like and self-like.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A computer-implemented system for generating context-appropriate language suggestions, the system comprising:
a first corpus storing reference exemplars indexed by one or more embeddings and optional linguistic metadata;
a second corpus storing at least one of: user specific prior productions, target style exemplars, and a user dictionary of studied words or phrases, the second corpus indexed by one or more embeddings and optional metadata; and
a controller configured to:
(i) construct, from dialogue context, a structured intent signature comprising intent parameters including at least communicative function and one or more of tone or stance, register, tense or aspect, domain, locale, or required information slots;
(ii) perform concurrent retrievals conditioned on the same intent signature from the first corpus and the second corpus to obtain respective sets of retrieved materials;
(iii) derive gating rules from the intent signature and one or more policy parameters;
(iv) condition a generator on at least the retrieved materials to produce candidate language suggestions;
(v) filter the candidate language suggestions using the gating rules; and
(vi) select one or more of the filtered candidate language suggestions for presentation to a user.

2. The system of claim 1, wherein the controller derives the gating rules to require at least one of: (i) particular syntactic forms; (ii) inclusion of one or more required information slots; (iii) particular semantic constraints; and (iv) exclusion of disallowed patterns.

3. The system of claim 1, wherein items in the second corpus include metadata comprising one or more of: timestamp, provenance identifier, domain label, locale, or style label.

4. The system of claim 1, wherein the gating rules enforce style-safety thresholds that limit at least one of: a token-level similarity measure and an n-gram overlap proportion between a candidate and any single reference item.

5. The system of claim 1, wherein conditioning the generator comprises providing, as part of the model input, one or more of: exemplar snippets, structured slot requirements, control tokens, or a vocabulary preference list.

6. The system of claim 1, wherein the controller filters the candidate language suggestions by rejecting any candidate that fails a gated constraint and selects among compliant candidates according to at least one of divergence reduction, policy weights, or voice/style similarity to user patterns.

7. The system of claim 1, wherein the controller writes back to the second corpus at least the intent signature, identifiers of retrieved items used during conditioning, and an identifier of the selected candidate.

8. The system of claim 1, wherein policy parameters specify vocabulary or syntactic scaffolding and the gating rules require or prefer inclusion of at least one item from a specified vocabulary list.

9. The system of claim 1, wherein selected candidates are presented directly to a user or routed through another interface for review or curation prior to presentation.

10. The system of claim 1, wherein the intent signature comprises discrete fields and one or more vector encodings representing the intent parameters.

11. The system of claim 1, wherein the controller selects two or more filtered candidate language suggestions for presentation as alternatives.

12. The system of claim 1, further comprising post-generation lexical injection in which the controller rewrites a compliant candidate to include one or more specified words or phrases derived from policy parameters or user selection and selects a minimally edited compliant rewrite when available.

13. A computer-implemented method for generating context-appropriate language suggestions, the method comprising: constructing, from dialogue context, a structured intent signature comprising intent parameters; performing concurrent retrievals conditioned on the same intent signature from a first corpus of reference exemplars and a second corpus of user-specific prior productions and/or target-style exemplars to obtain respective sets of retrieved materials; conditioning a generator on at least the retrieved materials to produce candidate language suggestions; deriving gating rules from the intent signature and policy parameters; filtering the candidate language suggestions using the gating rules; and selecting one or more of the filtered candidate language suggestions for presentation to a user.
